(19) United States
(12) Patent Application Publication
(10) Pub. No.: US 2015/0128462 A1
(43) Pub. Date: May 14, 2015

(54) THREE-DIMENSIONAL FORMING SYSTEM

(71) Applicant: Dimensional Communications, Inc., Old Saybrook, CT (US)

(72) Inventors: Christopher S. Crowell, Old Lyme, CT (US); Joseph Klim, New Britain, CT (US)

(21) Appl. No.: 14/323,768

(22) Filed: Jul. 3, 2014

Related U.S. Application Data
(60) Provisional application No. 61/842,695, filed on Jul. 3, 2013.

(51) Int. Cl. G09F 1/06; B32B 3/06

(52) U.S. Cl. CPC G09F 1/06; B32B 3/06; B32B 2250/03; B32B 2590/00
USPC 40/124.09; 428/101

(57) ABSTRACT

A three-dimensional forming system comprising at least a first outer panel, and at least a second outer panel, the first and second outer panels connecting at terminating ends to each other, and a shape maintaining mechanism connected between the first outer panel and the second outer panel, the shape maintaining mechanism having a first member and a second member, each member with a first tab and a second tab connected thereto. The first tabs are connected to each other at one end. The second tabs are respectively attached to one of the outer panels. The shape maintaining mechanism has a first configuration in which the first ends of the first tabs connected to each other are positioned away from a first terminating end of the first and second outer panels and a second configuration in which the first ends of the first tabs connected to each other are positioned adjacent to the first terminating end of the first and second outer panels.

### CROSS REFERENCE TO RELATED APPLICATION

This application claims priority under 35 USC §119 to U.S. Provisional Patent Application No. 61/842,695 filed on Jul. 3, 2013, whose entire contents are hereby incorporated by reference.

### TECHNICAL FIELD

The present invention relates to a three-dimensional forming system which can be used for various purposes and can take various three-dimensional shapes, including rectangular, square, three-dimensionally arcuate and other shapes and can be used for display purposes, as well as other situations in which a three-dimensionally shaped object is desired, but where the object can be stored or otherwise maintained in a substantially two-dimensional configuration.

### BACKGROUND OF THE INVENTION

Various three-dimensional forming objects are known in the art, including U.S. Pat. No. 7,596,896.

Thus, U.S. Pat. No. 7,596,896 is directed to a display system for providing and generating a visual display comprising a holding member and a support base. The present invention is directed to an object which has a first substantially two-dimensional configuration and a second three-dimensional configuration and which can maintain the three-dimensional configuration without the use of rubber bands, magnets or other elements.

### SUMMARY OF THE INVENTION

A three-dimensional forming system according to the present invention incorporates outer panels which have a first configuration which is substantially planar to one another and a second configuration in which the two panels define a three-dimensional space therebetween.

A three-dimensional forming system comprising at least a first outer panel, and at least a second outer panel, the first and second outer panels each having first and second terminating ends and the first and second outer panels connected to each other at their respective first and second terminating ends, and a shape maintaining mechanism connected between the first outer panel and the second outer panel, the shape maintaining mechanism having first and second members, each member having a first tab and a second tab, the first tab of the first member connected to the first tab of the second member at a first end and each first tab having a second end connected to the second tab of the same member, the second tab of the first member attached to the first outer panel and the second tab of the second member attached to the second outer panel so as to have a first configuration in which the first ends of the first tabs connected to each other are positioned away from the first terminating end of the first and second outer panels and a second configuration in which the first ends of the first tabs connected to each other are positioned adjacent to the first terminating end of the first and second outer panels.

The tension between the first and second outer panels in combination with the shape maintaining mechanism maintains the overall system in the closed or open configuration. Changing the configuration from closed to open and open to closed is accomplished by pressing the outer panels' terminating ends toward each other (closed to open) or by pressing the panels toward each other (open to closed).

A display member can be positioned between the panels. This display member, which can be a substantially flat member, can have various two-dimensional shapes for display purposes and the like and the panels themselves can have various overall shapes so as to form various three-dimensional objects, such as three-dimensional arcuate objects, rectangular objects, square objects and other three-dimensional objects by having the panels either being substantially unitary or having one or more fold lines within each panel.

### BRIEF DESCRIPTION OF THE PHOTOS AND DRAWINGS

FIG. 1A is a side view of the three-dimensional forming system similar to that shown in FIGS. 10-12, in which the system is shown in its two-dimensional closed configuration.

FIG. 1B is a side view of an embodiment of the present invention similar to FIG. 1A but without a display member between the first and second outer panels.

FIG. 2A is a view similar to FIG. 1A showing the three-dimensional forming system in its three-dimensional, open configuration.

FIG. 2B is a side view similar to FIG. 1B, but without the display member between the first and second outer panels.

FIG. 3A is a bottom view of the embodiment shown in FIGS. 1A and 2A showing the system in its closed, substantially flat configuration.

FIG. 3B is a bottom view of the embodiment shown in FIGS. 1B and 2B in its closed configuration.

FIG. 3C is an enlarged view of the shape maintaining mechanism in the closed configuration.

FIG. 4A is a bottom view of the embodiment shown in FIGS. 1A, 2A and 3A in its open configuration.

FIG. 4B is a bottom view of the embodiment shown in FIGS. 1B, 2B and 3B, in its open configuration.

FIG. 4C is an enlarged view of the shape maintaining mechanism in the open configuration.

FIG. 5 is a perspective view of another embodiment of the present invention in which each panel includes a fold line so as to form two subpanels with the view in FIG. 5 being in the closed configuration.

FIG. 6 shows the embodiment of FIG. 5 in the open, three-dimensional configuration.

FIG. 7 is a bottom view of the embodiment shown in FIGS. 5 and 6 in the closed configuration.

FIG. 8 is a bottom view of the embodiment shown in FIGS. 5, 6 and 7 in the open, three-dimensional configuration.

FIG. 9 shows an alternative embodiment in which the shape maintaining mechanism includes two sets of first and second members attached at corresponding ends of the first outer panel and the second outer panel. An optional display member is also shown.

FIG. 10 is a perspective view of an embodiment of the present invention showing a three-dimensional forming system in the three-dimensional (open) configuration.

FIG. 11 is a bottom view of the invention shown in FIG. 10 in its open configuration.

FIG. 12 is a bottom view of the invention shown in FIG. 10 in its closed configuration.

### DETAILED DESCRIPTION

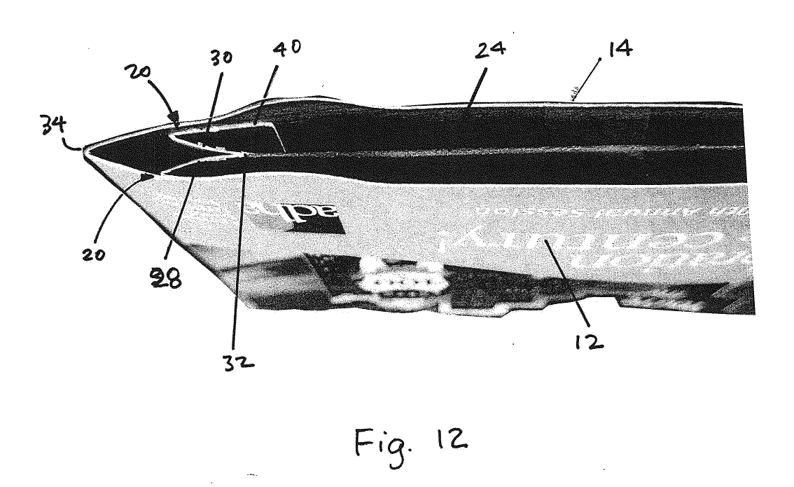

FIGS. 10-12 show an embodiment of the present invention in which the three-dimensional forming system 10 is in its open, three-dimensional configuration as shown in FIGS. 10 and 11 and in the closed, substantially flat configuration as shown in FIG. 12.

The three-dimensional forming system includes a first outer panel 12 and a second outer panel 14. The first outer panel includes an outer surface 16 and an inner surface 17 and the second outer panel includes an outer surface 18 and an inner surface 19. Display material can be placed on any or all of these surfaces. It should be noted that there may be multiple first outer panels 12 and/or multiple second panels 14, such as multiple first outer panels 12 positioned above shown panel 12. An optional display member 24 between panels 12 and 14 may also be present. This member may also include display material. This display member may be flat (planar) as shown or may be corrugated or have other non-planar shapes.

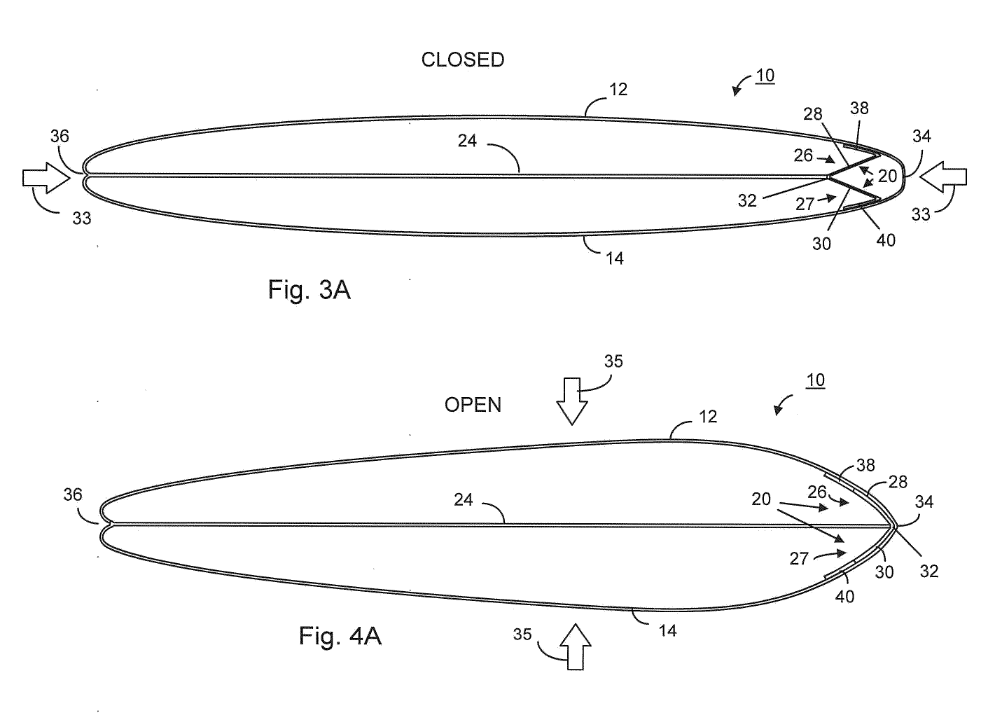

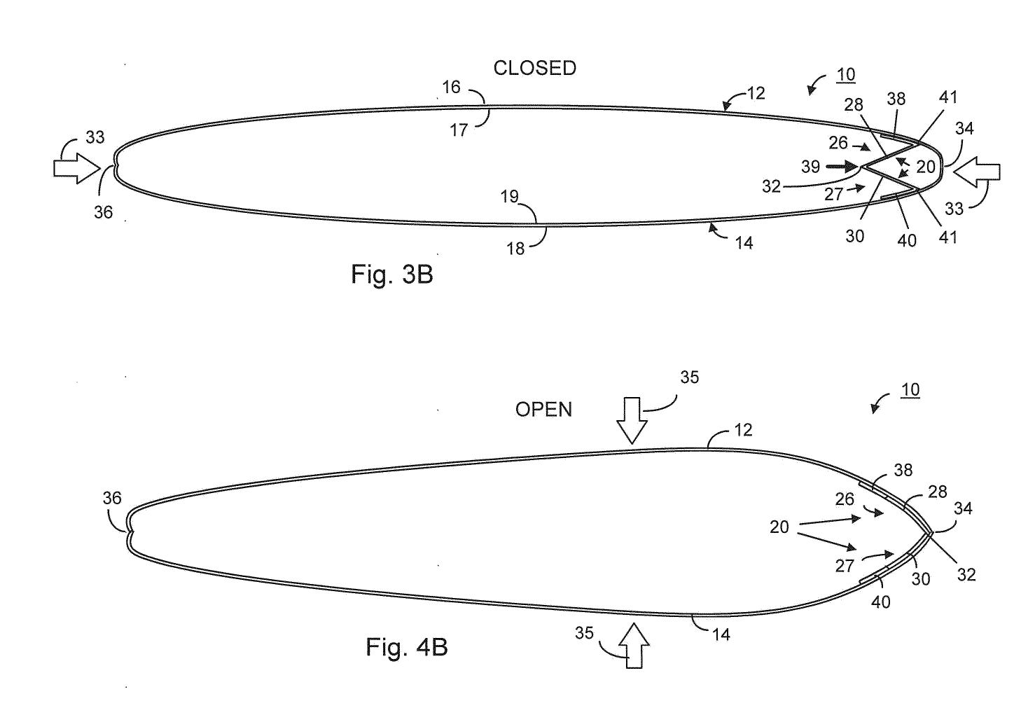

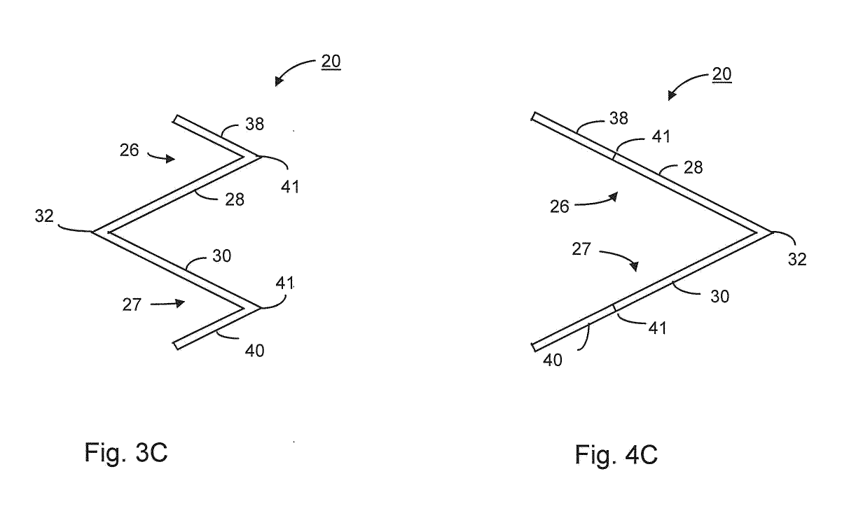

As best seen in FIGS. 3C and 4C, 11 and 12, the three-dimensional forming system also includes a shape maintaining mechanism 20 that comprises first member 26 and second member 27.

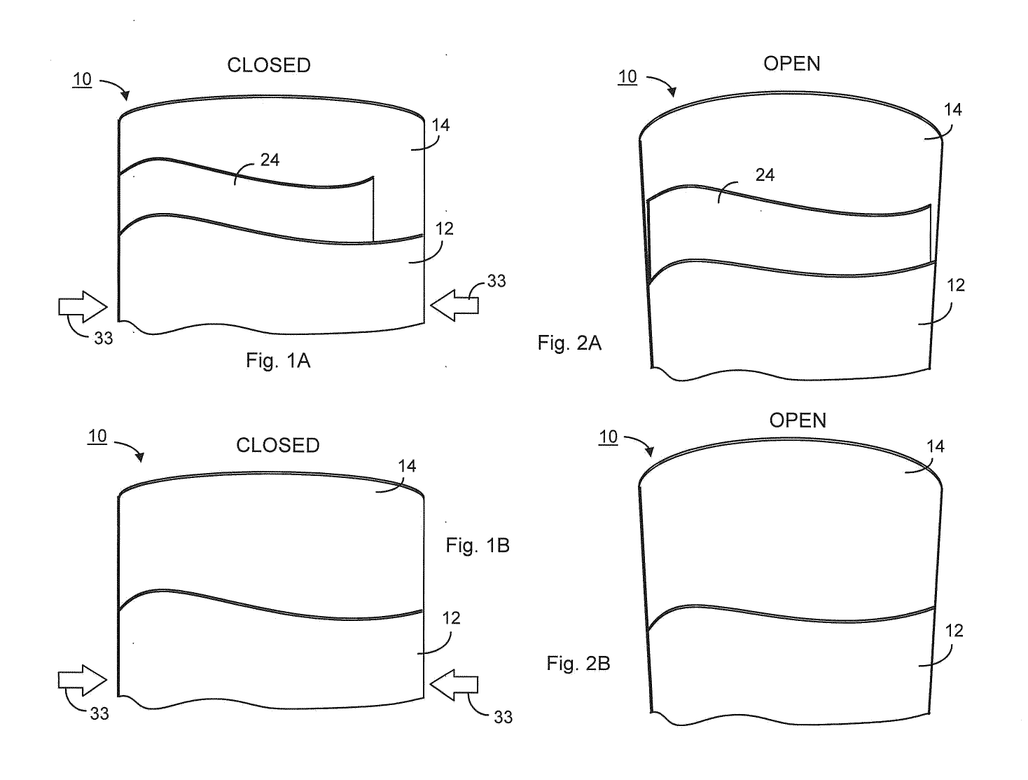

The operation of the three-dimensional forming system between its closed, substantially flat configuration as shown in FIGS. 1A, 1B, 3A, 3B and 3C, and its open, three-dimensional configuration as shown in FIGS. 2A, 2B, 4A, 4B and 4C is best understood with reference to FIGS. 1A-4C and FIGS. 11 and 12. Thus, it is seen that the shape maintaining mechanism 20 has first and second members 26 and 27, each member respectively having a first tab 28 and 30 and a second tab 38 and 40. The first tab 28 of the first member 26 is connected to the first tab 30 of the second member 27 at a first end 32 of tabs 28 and 30. The second tab 38 and 40 of each member is respectively attached to first outer panel 12 and second outer panel 14. This attachment can be made with glue or other forms of attachment known in the art, including the use of staples and the like. The first tab and second tab of each member are connected to each other at a second end 41.

As shown in FIG. 3A, the shape maintaining mechanism can have a first (closed) configuration in which first tabs 28 and 30 have the first end 32 positioned away from a first terminating end 34 where panels 12 and 14 attach to each other. This first end 32 may connect to a display member 24 if this display member is present (see FIGS. 1A, 2A, 3A and 4A).

In the second (open) configuration as shown in FIGS. 2A, 2B, 4A, 4B and 4C, the location of first end 32 of tabs 28 and 30 is adjacent first terminating end 34 where panels 12 and 14 attach to each other (panels 12 and 14 are also attached to each other at a second terminating end 36). This causes a reduction in the space between terminating end 34 and terminating end 36 of the first outer panel 12 and second outer panel 14 as best seen by comparison of FIG. 3A to FIG. 4A, and a comparison of FIG. 3B to FIG. 4B. This results in the first outer panel and second outer panel taking on a three-dimensional configuration as shown in FIGS. 2A, 2B, 4A, 4B, 10 and 11. The tension between the outer panels 12 and 14 in combination with the shape maintaining mechanism 20 maintains the overall system 10 in the open configuration. Application of pressure at each terminating ends 34 and 36 of the outer panels 12 and 14 as shown by arrows 33 moves the outer panels from the closed configuration (FIG. 3A) to the open configuration (FIG. 4A) if the display member is present. Otherwise, application of pressure on first end 32 toward first terminating end 34 performs the same function as that of display member 24 pushing on first end 32 (see arrow 39 in FIG. 3B). Application of pressure on the outer panels 12 and 14 toward each other as shown by arrows 35 in FIG. 4A moves the outer panels from the open configuration (FIG. 4A) to the closed configuration (FIG. 3A). Such operation is also achieved if a display panel 24 is present as shown in FIGS. 1B, 2B, 3B and 4B.

The overall three-dimensional forming system can be made from cardboard or other flat two-dimensional material. Various display material can be attached to any of the first and second outer panels, such as by printing thereon, as well as the optional display member 24.

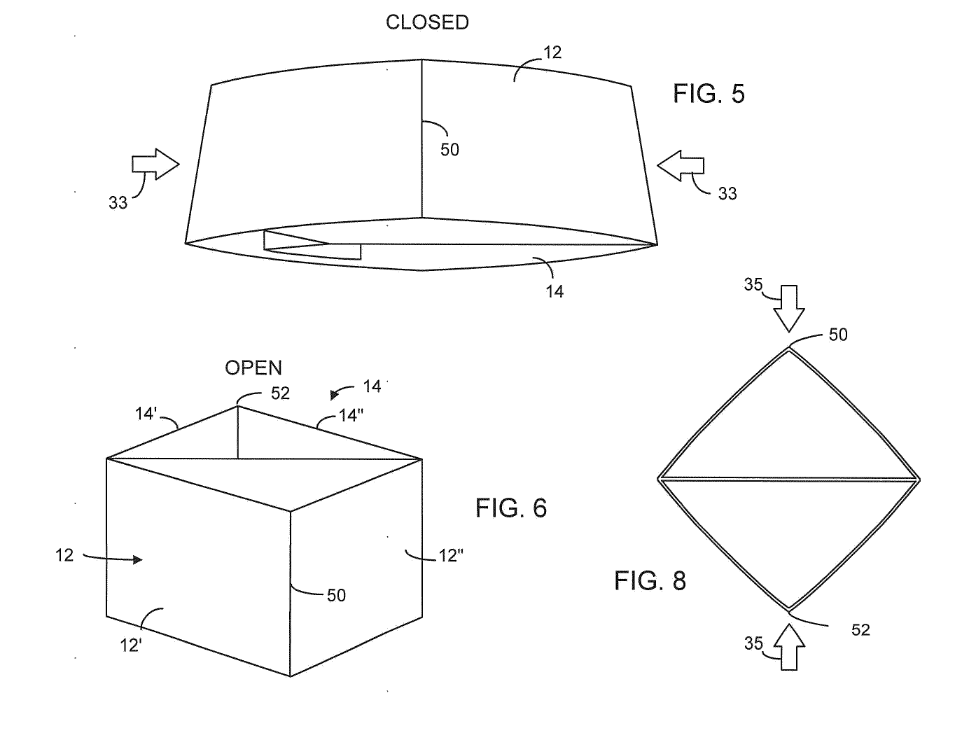

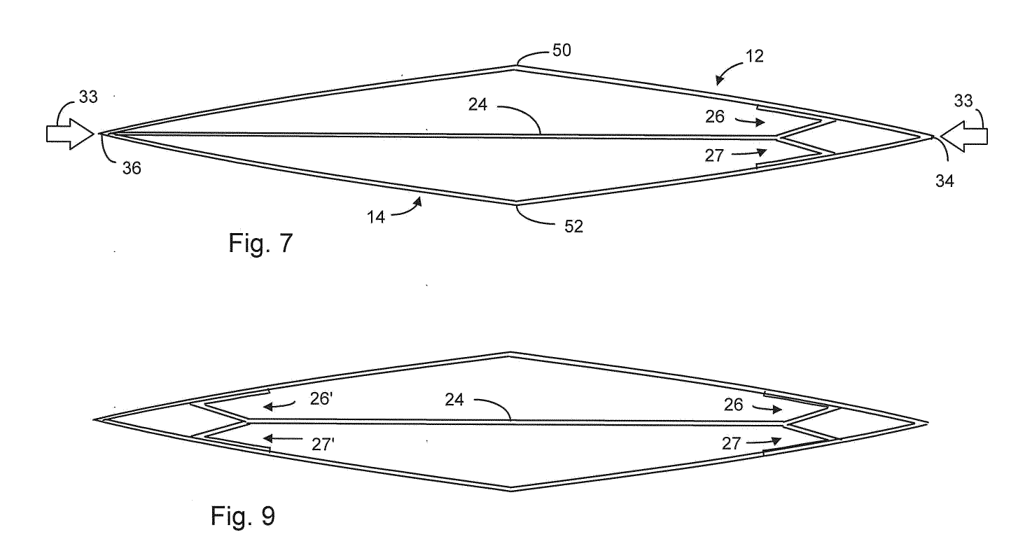

FIGS. 5-8 show a second configuration in which the first outer panel 12 and second outer panel 14 include a corresponding fold line 50 and 52 so that when in the open configuration, first outer panel 12 includes a first subpanel 12′ and a second subpanel 12″ and the second outer panel includes a first subpanel 14′ and a second subpanel 14′. Multiple fold lines could be used in addition to single fold lines for either or both outer panels.

Thus, the three-dimensional object can have four sides as shown in FIGS. 6 and 8 or multiple sides if multiple fold lines are associated with the first outer panel and/or the second outer panel.

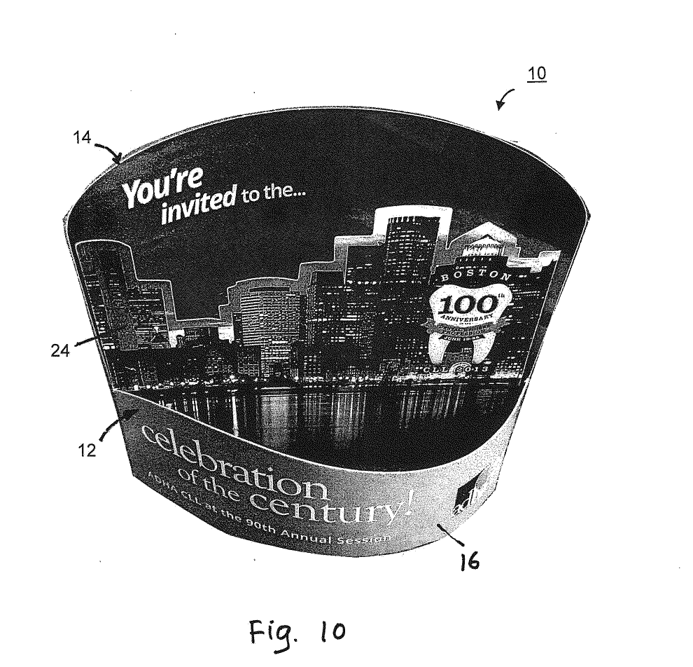

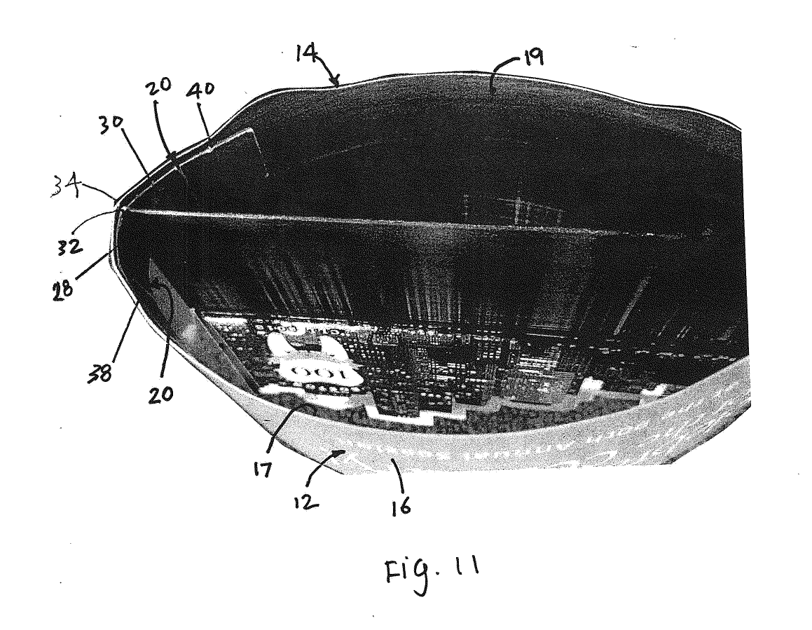

FIG. 9 shows an alternative embodiment of the present invention with respect to the shape maintaining mechanism 20 uses two sets of first and second members 26, 27; 26′, 27′. This embodiment may include a substantially flat member 24 connected to first set of first and second members 26, 27 and second set of first and second members 26′,27′ at respective ends of the substantially flat member. The configuration of each set of first and second members is substantially the same as that shown in FIGS. 3A, 4A, 3B and 4B.

Thus, the overall result is a three-dimensional forming system having first and second outer panels and a shape maintaining mechanism which eliminates the need for elastic bands, magnets or other shape maintaining devices.

While there have been shown and described and pointed out fundamental novel features of the invention as applied to preferred embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto. Furthermore, in the claims means-plus-function clauses are intended to cover the structures described herein as performing the recited function and not only structural equivalents, but also equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures.

What is claimed is:

1. A three-dimensional forming system comprising:
at least a first outer panel, and
at least a second outer panel,
the first and second outer panels each having first and second terminating ends and the first and second outer panels connected to each other at their respective first and second terminating ends, and
a shape maintaining mechanism connected between the first outer panel and the second outer panel, the shape maintaining mechanism having first and second members, each member having a first tab and a second tab, the first tab of the first member connected to the first tab of the second member at a first end and each first tab having a second end connected to the second tab of the same member, the second tab of the first member attached to the first outer panel and the second tab of the second member attached to the second outer panel so as to have a first configuration in which the first ends of the first tabs connected to each other are positioned away from the first terminating end of the first and second outer panels and a second configuration in which the first ends of the first tabs connected to each other are positioned adjacent to the first terminating end of the first and second outer panels.

2. The three-dimensional forming system according to claim 1, in which the first outer panel and/or the second outer panel includes at least one fold line so as to form subpanels with respect to the corresponding first outer panel and/or second outer panel.

3. The three-dimensional forming system according to claim 1, wherein at least one of the first and second outer panels have display materials on at least one side thereof.

4. The three-dimensional forming system according to claim 1, wherein at least two first outer panels and/or at least two second outer panels are respectively positioned relative to each other so that the first outer panels and/or second outer panels form an overall first outer panel and/or an overall second outer panel.

5. The three-dimensional forming system according to claim 1, further including a member positioned between the first outer panel and the second outer panel connected to the first end of first tab of the first member and the first tab of the second member so as to apply pressure thereto when pressure is applied to the first and second terminating ends of the first and second outer panels.

6. The three-dimensional forming system according to claim 5, wherein the member positioned between the first outer panel and the second outer panel is substantially flat.

7. The three-dimensional forming system according to claim 6, wherein the member positioned between the first outer panel and the second outer panel has display material on at least one side thereof.

8. The three-dimensional forming system according to claim 5, wherein the member positioned between the first outer panel and the second outer panel has display material on at least one side thereof.
